(19) United States
(12) Patent Application Publication
(10) Pub. No.: US 2017/0154206 A1
(43) Pub. Date: Jun. 1, 2017

(54) IMAGE PROCESSING METHOD AND APPARATUS

(71) Applicant: Xiaomi Inc., Beijing (CN)

(72) Inventors: Zhijun Chen, Beijing (CN); Pingze Wang, Beijing (CN); Baichao Wang, Beijing (CN)

(73) Assignee: Xiaomi Inc., Beijing (CN)

(21) Appl. No.: 15/291,652

(22) Filed: Oct. 12, 2016

(30) Foreign Application Priority Data
Nov. 26, 2015 (CN) 201510847294.6

(51) Int. Cl. G06K 9/00; G06K 9/62

(52) U.S. Cl. CPC G06K 9/00288; G06K 9/00228; G06K 9/6218

(57) ABSTRACT

Method and apparatus are disclosed for organizing photos into albums. Faces in the photos may be recognized and classified as faces of interest or faces of irrelevance. Electronic photo albums may then be established where each electronic album corresponds to a unique face among the faces of interest. Each photo may be assigned to one or more electronic album according to the faces of interest contained in the photo.

### CROSS-REFERENCE TO RELATED APPLICATIONS

This application is based on and claims a priority to Chinese Patent Application Serial No. CN 201510847294.6, filed with the State Intellectual Property Office of P. R. China on Nov. 26, 2015, the entire content of which is incorporated herein by reference.

### TECHNICAL FIELD

The present disclosure generally relates to the field of image processing technology, and more particularly, to methods and apparatus for processing images containing human faces.

### BACKGROUND

An electronic photo album (herein referred to as electronic album program, or album program, or electronic album, or simply, album) is a common application in a mobile terminal, such as a smart phone, a tablet computer, and a laptop computer, etc. The electronic album may be used for managing, cataloging, and displaying images in the mobile terminal.

In related art, the album program in the terminal may cluster all human faces appeared in a collection of images to into a set of unique human faces, so as to organize the collection of images into photon sets each corresponding to one of the faces within the set of unique faces.

### SUMMARY

Embodiments of the present disclosure provide an image processing method and an image processing apparatus. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for image processing management is disclosed. The method includes recognizing at least one human face contained in an image; acquiring a set of contextual characteristic information for each of the at least one recognized human face; classifying each of the at least one recognized human face as a face of interest or irrelevance according to the set of contextual characteristic information compared to a predetermined set of corresponding contextual criteria; and associating each face classified as a face of interest with an electronic photo album among a set of at least one photo album each associated with a unique human face.

In another embodiment, an image processing and management apparatus is disclosed. The apparatus includes a processor; and a memory for storing instructions executable by the processor, wherein the processor is configured to cause the apparatus to: identify at least one human face contained in an image; acquire a set of contextual characteristic information for each of the at least one recognized human face; classify each of the at least one recognized human face as a face of interest or irrelevance according to the set of contextual characteristic information compared to a predetermined set of corresponding contextual criteria; and associate each face classified as a face of interest with an electronic photo album among a set of at least one photo album each associated with a unique human face.

In yet another embodiment, a non-transitory computer-readable storage medium having stored therein instructions is disclosed. The instructions, when executed by a processor of a terminal, causes the terminal to identify at least one human face contained in an image; acquire a set of contextual characteristic information for each of the at least one recognized human face; classify each of the at least one recognized human face as a face of interest or irrelevance according to the set of contextual characteristic information compared to a predetermined set of corresponding contextual criteria; and associate each face classified as a face of interest with an electronic photo album among a set of at least one photo album each associated with a unique human face.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing an image processing method according to an illustrative embodiment.

FIG. 2 is a flow chart showing one implementation of step S103 of FIG. 1.

FIG. 3 is a flow chart showing another implementation of step S103 of FIG. 1.

FIG. 4 is a flow chart showing another implementation of step S103 of FIG. 1.

FIG. 5 is a flow chart showing another implementation of step S103 of FIG. 1.

FIG. 6 is a flow chart showing yet another implementation of step S103 of FIG. 1.

FIG. 7 is a flow chart showing another image processing method according to an illustrative embodiment.

FIG. 8 is a block diagram of an image processing apparatus according to an illustrative embodiment.

FIG. 9 is a block diagram for one implementation of the determining module 83 of FIG. 8.

FIG. 10 is a block diagram for another implementation of the determining module 83 of FIG. 8.

FIG. 11 is a block diagram for another implementation of the determining module 83 of FIG. 8.

FIG. 12 is a block diagram for another implementation of the determining module 83 of FIG. 8.

FIG. 13 is a block diagram for yet another implementation of the determining module 83 of FIG. 8.

FIG. 14 is a block diagram of another image processing apparatus according to an illustrative embodiment.

FIG. 15 is a block diagram of an image processing device according to an illustrative embodiment.

### DETAILED DESCRIPTION

Reference will be made in detail to embodiments of the present disclosure. Unless specified or limited otherwise, the same or similar elements and the elements having same or similar functions are denoted by like reference numerals throughout the descriptions. The explanatory embodiments of the present disclosure and the illustrations thereof are not be construed to represent all the implementations consistent with the present disclosure. Instead, they are examples of the apparatus and method consistent with some aspects of the present disclosure, as described in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”. Further, the term “image” and “photo” are used interchangeably in this disclosure.

Embodiments of the present disclosure provide an image processing method, and the method may be applied in various electronic devices such as a mobile terminal. The mobile terminal may be equipped with one or more cameras and capable of taking photos and storing the photos locally in the mobile terminal device. An application may be installed in the mobile terminal for providing an interface for a user to organize and view the photos. The application may organize the photos based on face clustering. In particular, the photos may be organized in albums each associated with a particular person and a subset of photos in which that particular person appears. Photos with multiple individuals thus may be associated with multiple corresponding albums. Those of ordinary skill in the art understand that the association between a person-based album and the photos may be implemented as pointers and thus the mobile terminal only needs to maintain a single copy of each photo in the local storage of the mobile terminal. The clustering of the photos into the albums may be automatically performed by the application via face recognition. Specifically, the application may detect unique faces in the collection of photos and build albums corresponding to the unique faces. However, not all the human faces appearing in the collection of photos in the mobile terminal are of interest to the user. For example, a photo may be taken in a crowded place and there may be many other bystanders in the photo. A usual clustering application based on face recognition would only recognize faces of these bystanders and automatically establish corresponding photo albums. This may not be what the user desires.

The embodiments of the present disclosure provide methods and apparatus that classify the recognized faces in a photo collection into faces of interest or irrelevance (such as faces of bystanders) based on detecting some contextual characteristics information of the recognized faces in the photos, and only organize the photos into albums corresponding to faces of interest. While the disclosure below uses a mobile terminal device as an example, the principle disclosed may be applied in other scenarios. For example, the same face classification may be used in a cloud server maintaining electronic photo albums for users. This disclosure does not intend to limit the context in which the methods and apparatus disclosed herein apply.

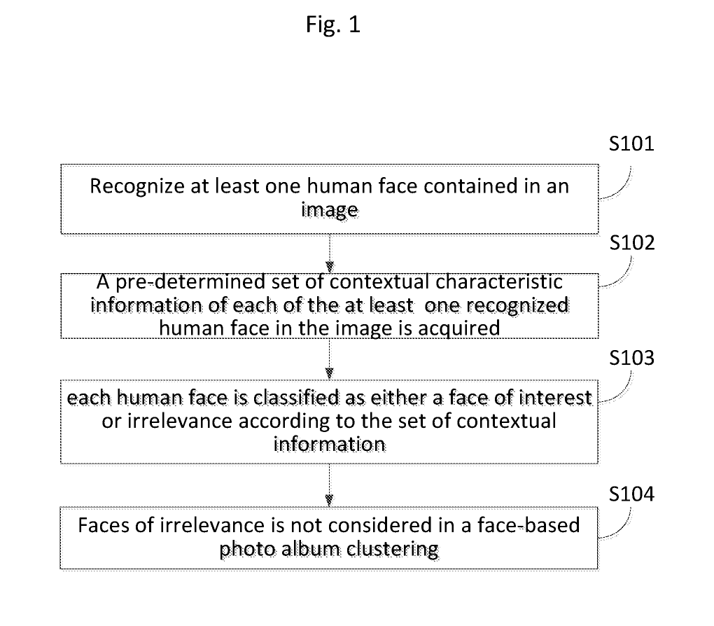

FIG. 1 shows a flow chart of a method for processing photos in the context of photo clustering according to the an exemplary embodiment of this disclosure. The method may include steps S101-S104. In step S101, the terminal device identifies at least one human face contained in an image or photo. In step S102, a pre-determined set of contextual characteristic information of each of the recognized human face is acquired. In step S103, each human face is classified as either a face of interest or irrelevance according to the set of contextual characteristic information for each recognized human face. In step S104, the faces classified as uninterested are removed from being considered as a basis for image clustering based on faces. In this way, when clustering the human faces identified from a collection of photos to obtain electronic photo albums each for a face of interest to the user, a face of irrelevance would not be assigned as an album. The method above thus prevents faces of people that have appeared coincidentally in images but are otherwise unrelated to the user from being a basis as establishing albums for them. The clustering of photos may thus be cleaner and more accurate, providing improved user experience.

For example, when a user takes a photo in a crowd scene, besides the target human face that the user wants to photograph (such as one of her friends), the photo may also include faces of a bystander that the user does not intend to photograph. Thus, the face of the bystander is unrelated and of irrelevance to the user. In the present disclosure, whether a human face recognized from a photo is of interest or irrelevance may be determined by the terminal device based on the contextual characteristic information obtained from imaging processing of the photo. As will be explained further below, the face of a bystander may have contextual characteristic information that the terminal device would reasonably conclude as indicating irrelevance. Thus, according to the method of FIG. 1, the face of this bystander may be ignored when clustering the photos into face-based albums and thus no album in the name of this bystander would be established. In this way, faces of people that the user did not intend to photograph, if accurately classified as faces of irrelevance based on the context characteristic information extracted for these faces, would not appear in the human face albums established by clustering.

The contextual characteristic information of a face may include at least one of: a position of the face in the image, an orientation angle of the human face in the image, depth information of the human face in the image, a size of the face in the image relative to the size of the image, and a number of times of the face has appeared in all images. Any one or combination of these and other contextual characteristic information may be used to determine whether the face should be classified as being of interest or irrelevance, as will be described in detail hereinafter.

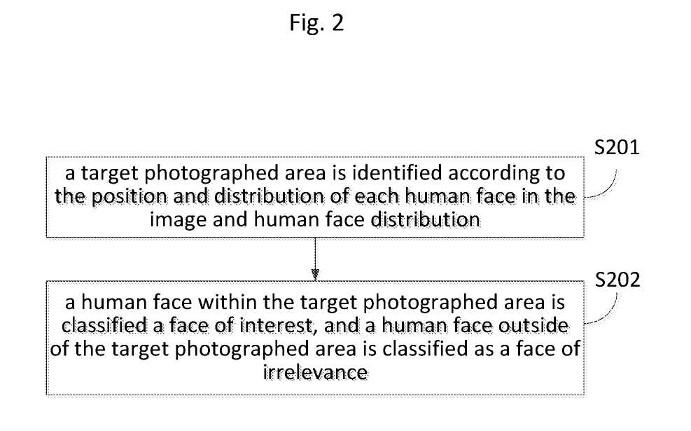

As shown in FIG. 2, in one implementation, if the contextual characteristic information of faces includes a position of the faces in the image, the step S103 of FIG. 1 may be implemented by steps S201-S205. In step S201, a target photographed area is determined according to the position of each human face in the image and human face distribution. In step S202, each human face located within the target photographed area is determined as a face of interest, and each human face located outside of the target photographed area is determined as a face of irrelevance. Thus, in this implementation, regardless of a whether a single human face or many human faces are contained in the image, the target photographed area may be determined according to the position of each human face in the image and the human face distribution. The target area may be determined as a fixed proportion of the image in a pre-specified relative location in the photo. For example, a 60% area at the center of image may be determined as the target area, human faces in the target photographed area are determined as the faces of interest, and human faces outside of the target photographed area are determined as of irrelevance. Alternatively, the target photographed area may be determined according to the content of the photo. For example, a photo may contain human faces concentrated in the part, e.g., center, the photo and scattered faces in other parts of the photo. It may then be determined that the part of the photo having concentrated human faces is the target photographed area.

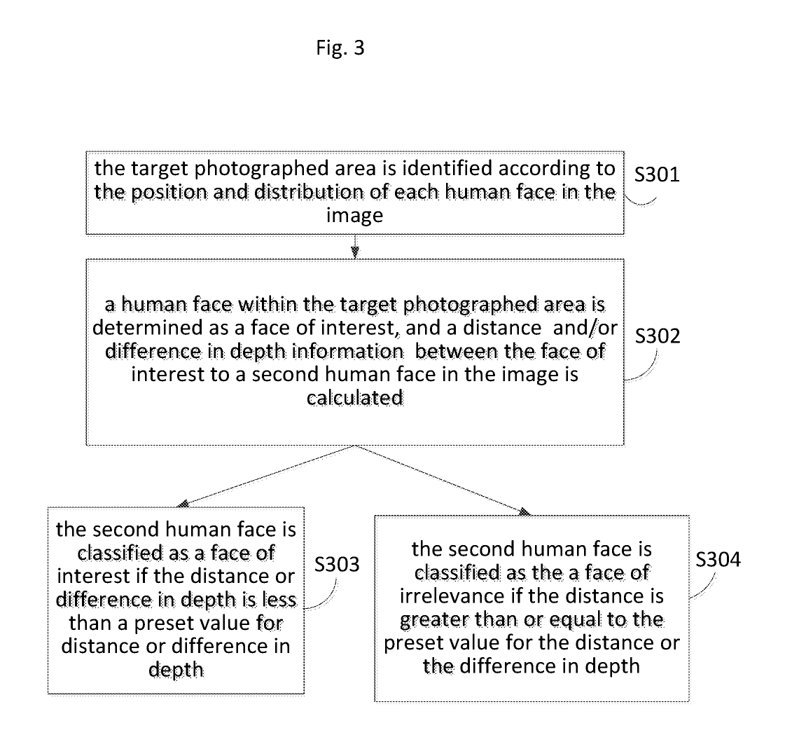

As shown in FIG. 3, in another implementation, when the contextual characteristic information includes positions of the human faces in the image or the depth information of the human face in the image, and there are at least two human faces in the image, step S103 of FIG. 1 may be implemented as steps S301-S304. The depth information of the human face represents how far the human face is away from the camera. The depth information may be obtained via imaging processing techniques. For example, the size of the face (in term of number of pixels occupied by the human face) in a photo may be evaluated to estimate the depth of the faces. Generally, faces with smaller size are most likely further away from the camera. In step S301, a target photographed area is determined according to the position of each human face in the image and human face distribution according to FIG. 2. In step S302, a human face within the target photographed area is determined as face of interest and a distance (in terms of number of pixel distance) from the determined face of interest to the other human face in the image is calculated or a difference between depth information of the face of interest and that of the other human face in the image is calculated. In step S303, the other human face is determined as a face of interest if the distance is less than a preset distance or the difference in depth is less than a preset difference. In step S304, the other human face is determined as a face of irrelevance if the distance is greater than or equal to the preset distance or the difference in depth is greater than or equal to the preset difference. Those of ordinary skill understand the two conditions may be used alone or in combination in determining whether a face outside the target photographed area is of interest or of irrelevance. When used in combination, the two conditions may be conjunctive or disjunctive. For example, a face may be classified as a face of interest when the calculated distance is smaller than the preset distance and the calculated depth difference is smaller than the preset depth difference. Correspondingly, the face may be classified as a face of irrelevance either when the calculated distance is not smaller than the preset distance or when the calculated depth difference is not smaller than the preset depth difference. Alternatively, a face may be classified as a face of interest either when the calculated distance is smaller than the preset distance or the calculated depth difference is smaller than the preset depth difference. Correspondingly, the face may be classified as a face of irrelevance when the calculated distance is not smaller than the preset distance and when the calculated depth difference is not smaller than the preset depth difference.

In this embodiment, when the image contains at least two human faces, the target photographed area may be determined according to the position of each human face in the image and the human face distribution. For example, the target photographed area is the center area of the image, and then a human face A in the center area may be determined as a face of interest. A distance from the A to the other one human face B in the image may be calculated. If the distance is less than the preset distance, then the human face B is also determined as a face of interest, giving rise to a set of face of interest: [A, B]. If the image further contains a human face C. A distance from the human face C to each of the set of faces of interest [A, B] is further calculated. If a distance from the human face C to any one in the set faces [A, B] is less than the preset distance, the human face C is determined as a face of interest. Whether other faces contained in the image are classified as faces of interest or irrelevance faces may be determined in a similar progressive way.

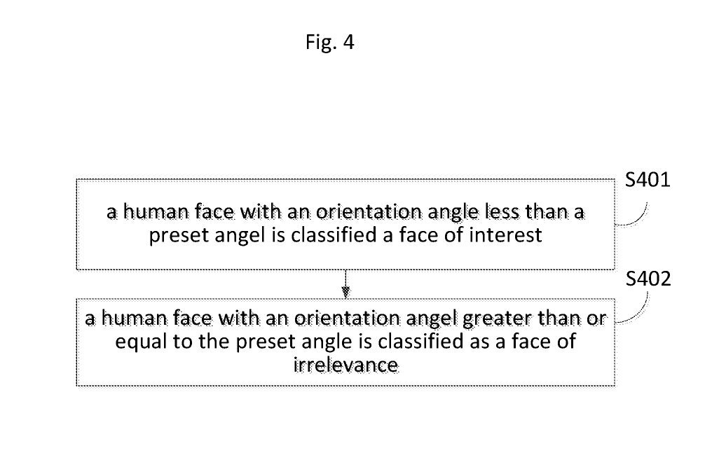

In another implementation, as shown in FIG. 4, when the contextual characteristic information of recognized faces includes the orientation angle of the faces in the image, step S103 of FIG. 1 may be implemented as steps S401-S402. In step S401, a human face with the orientation angle less than a preset angel is determined as a face of interest. In step S402, a human face with orientation angel greater than or equal to the preset angle is determined as a face of irrelevance.

Thus, in the implementation of FIG. 4, the orientation angle of a human face represents an angle the human face is turned away from the camera that was used for taking the image. For determining the facial orientation angle, facial features of each human face are positioned using some facial feature recognition algorithm, and the directional relationship between various facial features may be used to determine the orientation of each face. Specifically, a face that faces the camera lens when the photo was taken may be determined as a face of interest. That is, a face facing a forward direction may be determined as a face of interest. If the orientation angle of a face exceeds a certain angle (in other words, the face turned away from the camera by certain angle), it is determined to be a face of irrelevance.

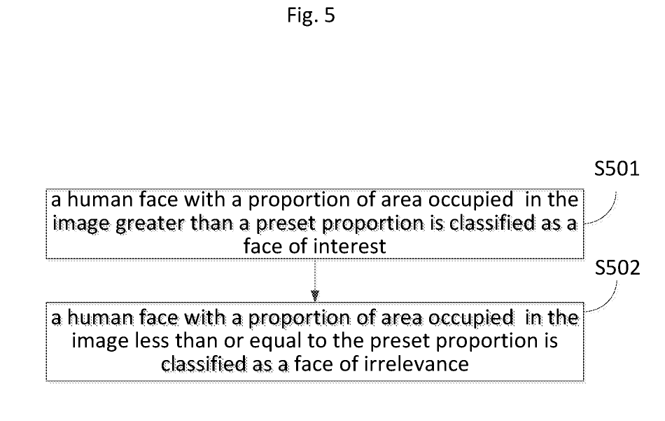

In another implementation, as shown in FIG. 5, when the contextual characteristic information of a face includes the size of the face relative to the size of the photo, step S103 of FIG. 1 may be implemented in steps S501-S502. In step S501, a human face with a ratio between the size of the face and the size of the photo (measure in, for example number of occupied pixels) greater than a preset value may be determined as a face of interest. In step S502, a human face with a ratio less than or equal to the preset value may be determined as a face of irrelevance. In particular, a relatively large ratio indicates that the face may be a main photographed object, and thus the face may be of interest. A relatively small ratio, on the other hand, indicates that the human face may not be the main photographed object, but may likely be an unintentionally photographed bystander. The face thus may be determined as a face of irrelevance.

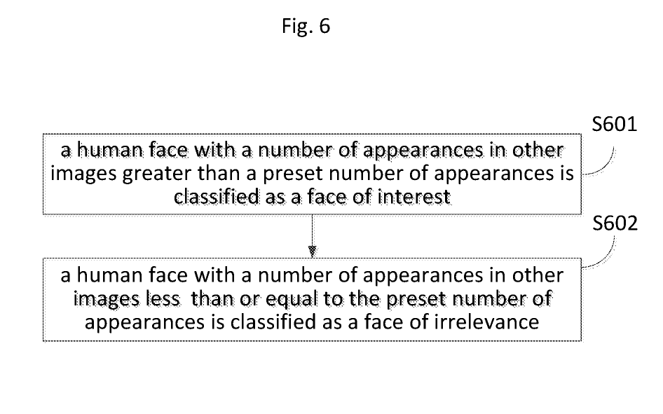

In another implementation, as shown in FIG. 6, when the contextual characteristic information of a face may include a number of times that face has appeared in other photos (or the entire collection of photos), step S103 of FIG. 1 may be implemented as steps S601-S602. In step S601, a frequently appearing face with a number of appearance more than a preset value may be determined as a face of interest. In step S602, a face with a number of appearances less than or equal to the preset value may be determined as a face of irrelevance. In particular, a face that appears frequency is likely to be a face of the user or her close acquaintances. On the other hand, a face that appears infrequently (e.g., once) is likely a face belonging to a bystander.

The classification of a face into either a face of interest or irrelevance may be based on any two or more items of the contextual characteristic information discussed above. For example, if the contextual characteristic information of a face includes the position of the face in the image and the orientation angle of the face in the image, the methods of determining whether the face is of interest corresponding to these two items of contextual characteristic information may be used additively. For example, the target photographed area may be determined according to the position of each human face in the image and the human face distribution. A human face within the target photographed area is determined as a face of interest. For a human face outside the target photographed area, the orientation angle may be used to determine whether that face is of interest. A face outside the target photographed area with an orientation angle smaller than a preset angle may be determined as a face of interest. On the contrary, a human face in the target photographed area but with an orientation angle greater than or equal to the preset angle may be determined as a face of irrelevance together with faces outside of the target photographed area.

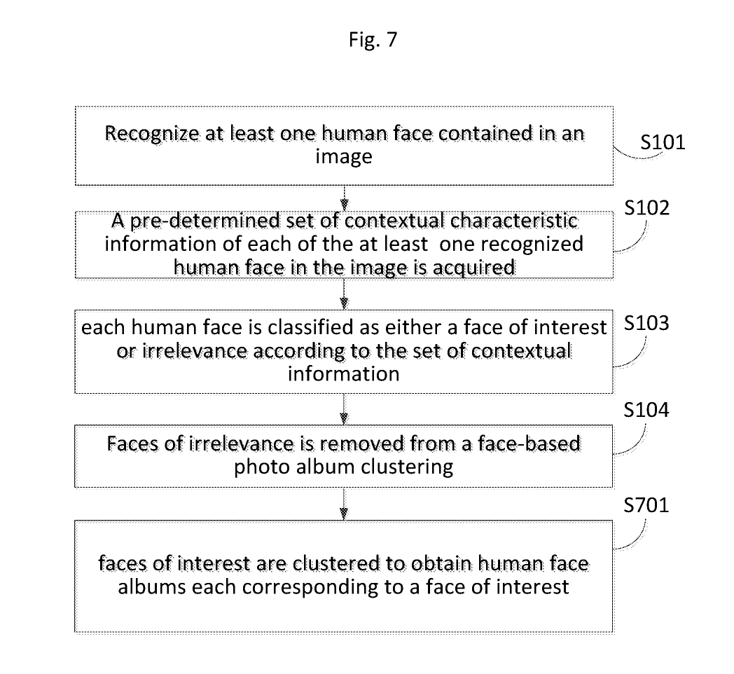

As shown in FIG. 7, the above methods may further include step S701, in which each face of interest is clustered to obtain an album corresponding to the each face of interest. Specifically, the application of the terminal device may keep track of all faces of interest, and de-duplicate them such that each face of interest is unique. The application may associate each photo in the collection of photos contain human faces with one or more albums. Some photos may be associated with multiple albums because they may contain multiple faces of interest. The photos that contain no human faces may be placed in to a special album that is not associated with any face.

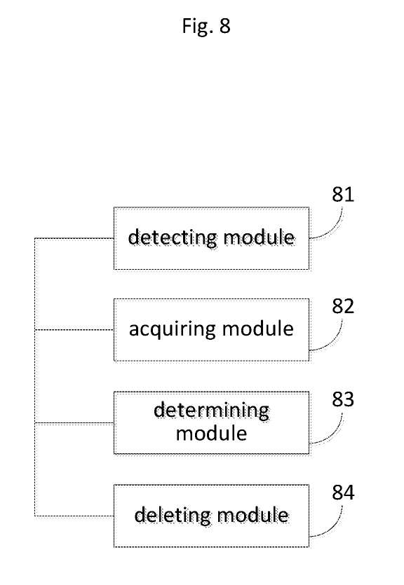

Various Apparatus are further disclosed below for implementing the methods described above. FIG. 8 is a block diagram for an image processing apparatus according to an illustrative embodiment. The apparatus may be implemented as all or a part of a server by hardware, software or combinations thereof. As shown in FIG. 8, the image processing apparatus includes a detecting module 81, an acquiring module 82, a determining module 83, and a deleting module 84. The detecting module 81 is configured to process an image and identify at least one face contained in the image. The acquiring module 82 is configured to acquire contextual characteristic information of each human face recognized by the detecting module 81 in the image. The determining module 83 is configured to classify each human face as either a face of interest or irrelevance face according to the contextual characteristic information of the face acquired by the acquiring module 82. The deleting module 84 is configured to remove faces irrelevance identified by module 83 from consideration for establishing any photo album associated with them.

In one implementation, the contextual characteristic information includes at least one of: a position of the human face in the image, an orientation angle of the human face in the image, depth information of the human face in the image, a size of the face relative to the size of the image, and a number of times of the face has appeared in the collection of images. Whether a face is of interest or irrelevance is determined according to one or more pieces of the aforementioned contextual information.

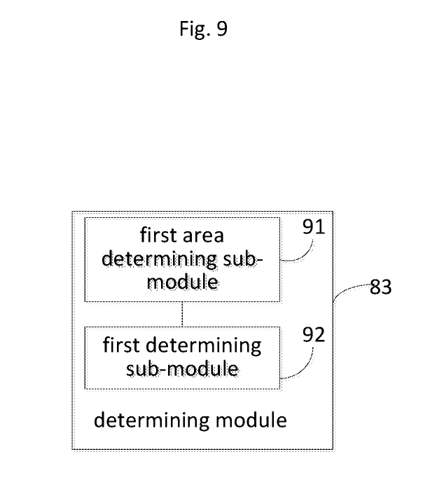

As shown in FIG. 9, in one implementation, the determining module 83 may include a first area determining sub-module 91 and a first determining sub-module 92. The first area determining sub-module 91 is configured to determine a target photographed area according to the position of each human face in the image and human face distribution. The first determining sub-module 92 is configured to determine a human face in the target photographed area determined by the first area determining sub-module 91 as a face of interest, and determine a face outside the target photographed area as a face of irrelevance. For example, an area at the center of image is determined as the target area, human faces within the target photographed area are determined as faces of interest. Faces outside of the target photographed area are determined as faces of irrelevance.

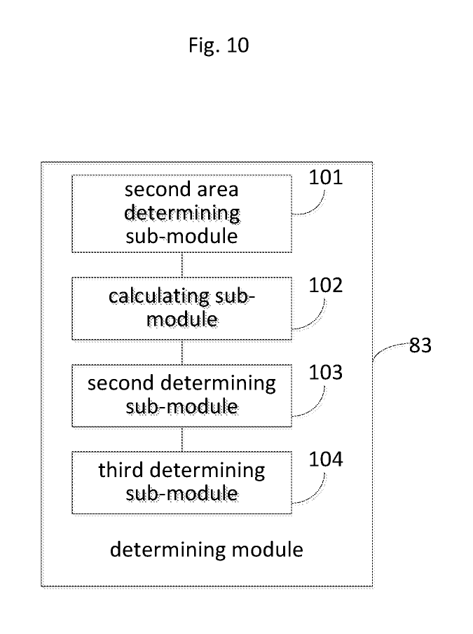

In another implementation shown in FIG. 10, when the contextual characteristic information includes the position of the human face in the image or the depth information of the human face in the image, and there are at least two human faces in the image, the determining module 83 may include a second area determining sub-module 101, a calculating sub-module 102, a second determining sub-module 103 and a third determining sub-module 104. The second area determining sub-module 101 is configured to determine a target photographed area according to the position of each human face in the image and human face distribution. The calculating sub-module 102 is configured to identify a human face in the target photographed area as being of interest, calculate a distance from the identified face to another face in the image or calculate a difference between depth information of the identified face and depth information of the other face in the image. The second determining sub-module 103 is configured to determine the other human face as a face of interest if the distance is less than a preset distance or the difference is less than a preset difference. The third determining sub-module 104 is configured to determine the other face as a face of irrelevance if the distance is greater than or equal to the preset distance or the difference is greater than or equal to the preset difference.

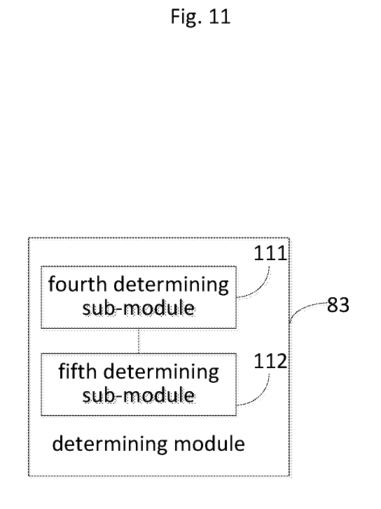

In another implementation shown in FIG. 11, if the contextual characteristic information includes the orientation angle of human faces in the image, the determining module 83 may include a fourth determining sub-module 111 and a fifth determining sub-module 112. The fourth determining sub-module 111 is configured to determine a human face with the orientation angle less than a preset angel as a face of interest. The fifth determining sub-module 112 is configured to determine a human face with the orientation angel greater than or equal to the preset angle as a face of irrelevance. Thus, the orientation of faces in the image is used to determine whether a face is of interest.

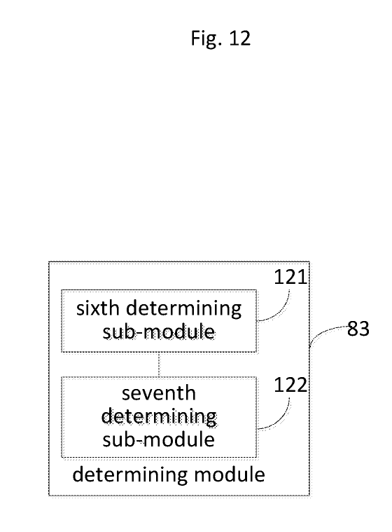

In another implementation shown in FIG. 12, if the contextual characteristic information includes the size of faces in the image relative to the size of the image, the determining module 83 may include a sixth determining sub-module 121 and a seventh determining sub-module 122. The sixth determining sub-module 121 is configured to determine a human face with a proportion (size of the face over the size of the image) greater than a preset value as a face of interest. The seventh determining sub-module 122 is configured to determine a human face with the proportion less than or equal to the preset proportion as a face of irrelevance.

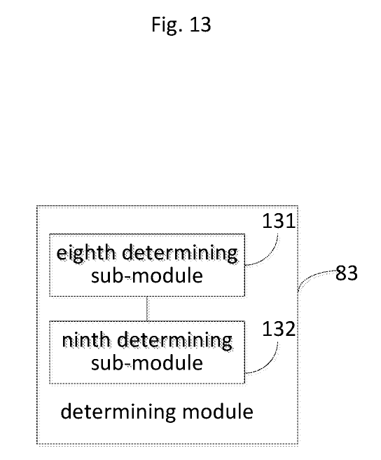

In another implementation as shown in FIG. 13, if the contextual characteristic information includes the number of times of a face appearing in the collection of images on the mobile terminal device, the determining module 83 may include an eighth determining sub-module 131 and a ninth determining sub-module 132. The eighth determining sub-module 131 is configured to determine a face with more frequent appearances in other images than a preset value as a face of interest. The ninth determining sub-module 132 is configured to determine a face with equal or less frequent appearance in other images than the preset value as a face of irrelevance.

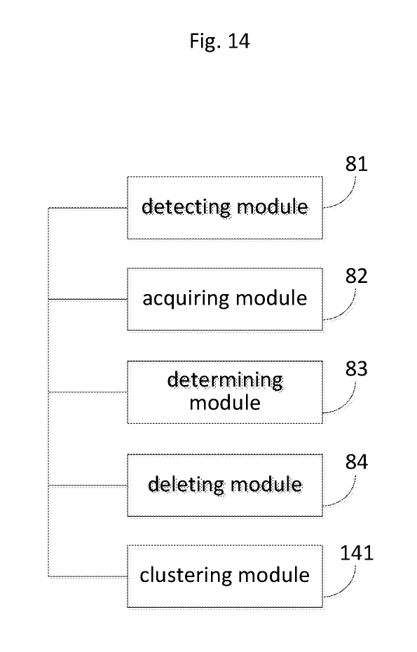

The above apparatus may further include a clustering module 141, as illustrated in FIG. 14. The clustering module 141 is configured to cluster the faces of interest to obtain human face albums each corresponding to a face of interest.

According to another aspect of the present disclosure, an image processing apparatus is provided, including a processor, and a memory for storing instructions executable by the processor, in which the processor is configured to cause the apparatus to perform the methods described above.

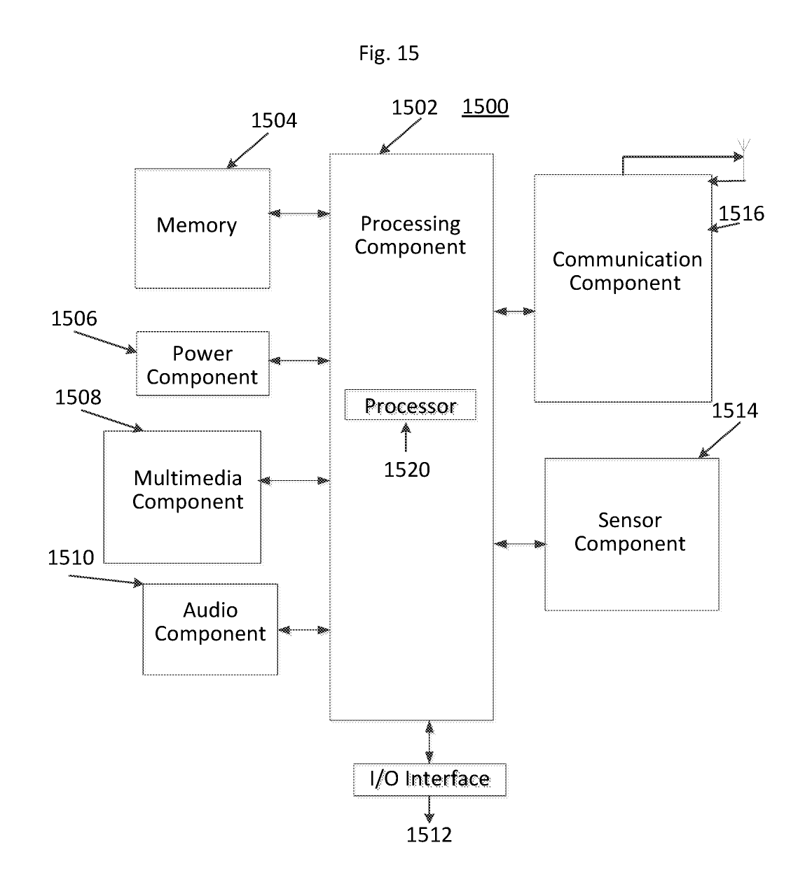

FIG. 15 is a block diagram of an image processing device according to an illustrative embodiment; the device is applied to a terminal device. For example, the device 1500 may be a mobile phone, a computer, a digital broadcast terminal, a messaging device, a gaming console, a tablet, a medical device, exercise equipment, a personal digital assistant, and the like.

The device 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 controls overall operations of the device 1500, such as the operations associated with display, telephone calls, data communications, camera operations, and recording operations. The processing component 1502 may include one or more processors 1520 to execute instructions to perform all or part of the steps in the above described methods. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the device 1500. Examples of such data include instructions for any applications or methods operated on the device 1500, contact data, phonebook data, messages, pictures, video, etc. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the device 1500. The power component 1506 may include a power management system, one or more power sources, and any other components associated with the generation, management, and distribution of power in the device 1500.

The multimedia component 1508 includes a display screen providing an output interface between the device 1500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and the rear camera may receive an external multimedia datum while the device 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone (“MIC”) configured to receive an external audio signal when the device 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the device 1500. For instance, the sensor component 1514 may detect an open/closed status of the device 1500, relative positioning of components, e.g., the display and the keypad, of the device 1500, a change in position of the device 1500 or a component of the device 1500, a presence or absence of user contact with the device 1500, an orientation or an acceleration/deceleration of the device 1500, and a change in temperature of the device 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor or thermometer.

The communication component 1516 is configured to facilitate communication, wired or wirelessly, between the device 1500 and other devices. The device 1500 can access a wireless network based on a communication standard, such as WiFi, 2G, 3G, LTE, or 4G cellular technologies, or a combination thereof. In one exemplary embodiment, the communication component 1516 receives a broadcast signal or broadcast associated information from an external broadcast management system via a broadcast channel. In one exemplary embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In illustrative embodiments, there is also provided a non-transitory computer-readable storage medium including instructions, such as a memory 1504 including instructions, the instructions may be executable by the processor 1520 in the device 1500, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium is further disclosed. The storage media have stored therein instructions that, when executed by a processor of the device 1500, causes the device 1500 to perform the above image processing method.

Each module or unit discussed above for FIG. 8-10, such as the detecting module, the acquiring module, the determining module, the deleting module, the first area determining sub-module, the first through the ninth determining sub-modules, the second area determining sub-module, and the clustering module may take the form of a packaged functional hardware unit designed for use with other components, a portion of a program code (e.g., software or firmware) executable by the processor 1520 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. An image processing management method, comprising:
recognizing at least one human face contained in an image;
acquiring a set of contextual characteristic information for each of the at least one recognized human face;
classifying each of the at least one recognized human face as a face of interest or irrelevance according to the set of contextual characteristic information compared to a predetermined set of corresponding contextual criteria; and
associating each face classified as a face of interest with an electronic photo album among a set of at least one photo album each associated with a unique human face.

2. The method according to claim 1, wherein the set of contextual characteristic information of a human face in an image comprises at least one of: a position of the human face in the image, an orientation angle of the human face in the image, depth information of the human face in the image, a proportion of an area occupied by the human face in the image, or a number of appearances of the human face in at least one other image.

3. The method according to claim 2, wherein classifying each of the at least one recognized human face as a face of interest or irrelevance according to the set of contextual characteristic information compared to the predetermined set of corresponding contextual criteria comprises:
identifying a target photographed area based on position and distribution of each of the at least one recognized human face in the image; and
classifying a human face within the target photographed area as a face of interest, and classifying a human face outside the target photographed area as a face of irrelevance.

4. The method according to claim 1,
wherein the set of contextual characteristic information for each recognized human face comprises a position or depth of each recognized human face;
wherein the at least one recognized human face comprises two or more human faces; and
wherein classifying each of the at least one recognized human face as a face of interest or irrelevance according to the set of contextual characteristic information compared to the predetermined set of corresponding contextual criteria comprises:
identifying a target photographed area based on the position of each of the at least one recognized human face in the image;
classifying a human face within the target photographed area as a face of interest;
calculating one of a distance or difference in depth between the human face classified as a face of interest to a second recognized human face outside the target photographed area in the image;
classifying the second recognized human face as a face of interest if the calculated distance is less than a preset distance or the calculated difference in depth is less than a preset difference in depth; and
classifying the second recognized human face as a face of irrelevance if the calculated distance is larger than or equal to the preset distance or the calculated difference in depth is larger than or equal to the preset difference in depth.

5. The method according to claim 1,
wherein the set of contextual characteristic information for each recognized human face comprises an orientation for each recognized human face in the image; and
wherein classifying each of the at least one recognized human face as a face of interest or irrelevance according to the set of contextual characteristic information compared to a predetermined set of corresponding contextual criteria comprises:
classifying a human face with an orientation angle less than a preset angle as a face of interest; and
classifying a human face with an orientation angle larger than or equal to the preset angle as a face of irrelevance.

6. The method according to claim 1,
wherein the set of contextual characteristic information for each recognized human face comprises a proportion of the area occupied by the human face in the image; and
wherein classifying each of the at least one recognized human face as a face of interest or irrelevance according to the set of contextual characteristic information compared to a predetermined set of corresponding contextual criteria comprises:
classifying a human face with a proportion larger than a preset proportion value as a face of interest; and
classifying a human face with a proportion less than or equal to the preset proportion value as face of irrelevance.

7. The method according to claim 2,
wherein the set of contextual characteristic information for each recognized human face comprises a number of appearances the recognized human face has appeared in at least one other image; and
wherein classifying each of the at least one recognized human face as a face of interest or irrelevance according to the set of contextual characteristic information compared to a predetermined set of corresponding contextual criteria comprises:
classifying a human face with a number of appearances in other images greater than a preset number of appearances as a face of interest; and
classifying a human face with a number of appearance in other images less than or equal to the preset number of appearances as a face of irrelevance.

8. An image processing and management apparatus, comprising:
a processor; and
a memory for storing instructions executable by the processor,
wherein the processor is configured to cause the apparatus to:
identify at least one human face contained in an image;
acquire a set of contextual characteristic information for each of the at least one recognized human face;
classify each of the at least one recognized human face as a face of interest or irrelevance according to the set of contextual characteristic information compared to a predetermined set of corresponding contextual criteria; and
associate each face classified as a face of interest with an electronic photo album among a set of at least one photo album each associated with a unique human face.

9. The apparatus according to claim 8, wherein the set of contextual characteristic information of a human face in an image comprises at least one of: a position of the human face in the image, an orientation angle of the human face in the image, depth information of the human face in the image, a proportion of an area occupied by the human face in the image, or a number of appearances of the human face in at least one other image.

10. The apparatus according to claim 9, wherein to classify each of the at least one recognized human face as a face of interest or irrelevance according to the set of contextual characteristic information compared to the predetermined set of corresponding contextual criteria, the processor is configured to cause the apparatus to:
identify a target photographed area based on position and distribution of each of the at least one recognized human face in the image; and
classify a human face within the target photographed area as a face of interest, and classify a human face outside the target photographed area as a face of irrelevance.

11. The apparatus according to claim 8,
wherein the set of contextual characteristic information for each recognized human face comprises a position or depth of each recognized human face;
wherein the at least one recognized human face comprises two or more human faces; and
wherein to classify each of the at least one recognized human face as a face of interest or irrelevance according to the set of contextual characteristic information compared to a predetermined set of corresponding contextual criteria, the processor is configured to cause the apparatus to
identify a target photographed area based on the position of each of the at least one recognized human face in the image;
classify a human face within the target photographed area as a face of interest
calculate a distance or difference in depth between the human face classified as a face of interest to a second recognized human face outside the target photographed area in the image;
classify the second recognized human face as a face of interest if the calculated distance is less than a preset distance or the calculated difference in depth is less than a preset difference in depth; and
classify the second recognized human face as a face of irrelevance if the calculated distance is larger than or equal to the preset distance or the calculated difference in depth is larger than or equal to the preset difference in depth.

12. The apparatus according to claim 8,
wherein the set of contextual characteristic information for each recognized human face comprises an orientation angle for each recognized human face in the image; and
wherein to classify each of the at least one recognized human face as a face of interest or irrelevance according to the set of contextual characteristic information compared to a predetermined set of corresponding contextual criteria, the processor is configured to cause the apparatus to
classify a human face with an orientation angle less than a preset angle as a face of interest; and
classify a human face with an orientation angle larger than or equal to the preset angle as a face of irrelevance.

13. The apparatus according to claim 8,
wherein the set of contextual characteristic information for each recognized human face comprises a proportion of the area occupied by the human face in the image; and
wherein to classify each of the at least one recognized human face as a face of interest or irrelevance according to the set of contextual characteristic information compared to a predetermined set of corresponding contextual criteria, the processor is configured to cause the apparatus to:
classify a human face with a proportion larger than a preset proportion value as a face of interest; and
classify a human face with a proportion less than or equal to the preset proportion value as face of irrelevance.

14. The apparatus according to claim 8,
wherein the set of contextual characteristic information for each recognized human face comprises a number of appearances the recognized human face has appeared in at least one other image; and
wherein to classify each of the at least one recognized human face as a face of interest or irrelevance according to the set of contextual characteristic information compared to a predetermined set of corresponding contextual criteria, the processor is configured to cause the apparatus to:
classify a human face with a number of appearances in other images greater than a preset number of appearances as a face of interest; and
classify a human face with a number of appearance in other images less than or equal to the preset number of appearances as a face of irrelevance.

15. A non-transitory computer-readable storage medium having stored therein instructions that, when executed by a processor of a terminal, causes the terminal to:
identify at least one human face contained in an image;
acquire a set of contextual characteristic information for each of the at least one recognized human face;
classify each of the at least one recognized human face as a face of interest or irrelevance according to the set of contextual characteristic information compared to a predetermined set of corresponding contextual criteria; and
associate each face classified as a face of interest with an electronic photo album among a set of at least one photo album each associated with a unique human face.
